(19) United States
(12) Patent Application Publication
(10) Pub. No.: US 2020/0100296 A1
(43) Pub. Date: Mar. 26, 2020

(54) Listen before Talk and Channel Access Priority Class for RACH in New Radio Unlicensed

(71) Applicant: MediaTek Singapore Pte. Ltd., Singapore (SG)

(72) Inventors: Abhishek Roy, San Jose, CA (US); Pavan Santhana Krishna Nuggehalli, San Jose, CA (US)

(21) Appl. No.: 16/577,118

(22) Filed: Sep. 20, 2019

Related U.S. Application Data
(60) Provisional application No. 62/736,513, filed on Sep. 26, 2018.

(51) Int. Cl. H04W 74/08; H04W 72/10; H04W 72/14

(52) U.S. Cl. CPC H04W 74/0833; H04W 36/0055; H04W 72/14; H04W 72/10

(57) ABSTRACT

A method for determining Listen Before Talk (LBT) type and Channel Access Priority Class (CAPC) for Physical Random Access Channel (PRACH) transmission in 5G New Radio-Unlicensed (NR-U) is proposed. UE selects a priority of the RACH procedure, depending on the triggering event. UE also selects Category 4 LBT and determines a suitable CAPC based on RACH priority for the PRACH transmission. UE then performs the Category 4 LBT procedure using a set of LBT parameters associated with the determined CAPC value. The RACH procedure has a higher priority if triggered by a beam failure recover (BFR) procedure or a handover (HO) procedure and high priority CAPC is assigned for the corresponding LBT procedure. The RACH procedure has a low priority if triggered by all other reasons and low priority CAPC is assigned for the corresponding LBT procedure.

### CROSS REFERENCE TO RELATED APPLICATIONS

This application claims priority under 35 U.S.C. § 119 from U.S. Provisional Application No. 62/736,513, entitled “LBT Type and CAPC for RACH in NR-U,” filed on Sep. 26, 2018, the subject matter of which is incorporated herein by reference.

### TECHNICAL FIELD

The disclosed embodiments relate generally to wireless network communications, and, more particularly, to physical random access channel (PRACH) design in 5G new radio unlicensed (NR-U) wireless communications systems.

### BACKGROUND

Third generation partnership project (3GPP) and Long Term Evolution (LTE) mobile telecommunication systems provide high data rate, lower latency and improved system performances. With the rapid development of “Internet of Things” (IOT) and other new user equipment (UE), the demand for supporting machine communications increases exponentially. To meet the demand of this exponential increase in communications, additional spectrum (i.e. radio frequency spectrum) is needed. The amount of licensed spectrum is limited. Therefore, communications providers need to look to unlicensed spectrum to meet the exponential increase in communication demand. One suggested solution is to use a combination of licensed spectrum and unlicensed spectrum. This solution is referred to as “Licensed Assisted Access” or “LAA”. In such a solution, an established communication protocol such as LTE and 5G New Radio (NR) can be used over the licensed spectrum to provide a first communication link, and LTE can also be used over the unlicensed spectrum to provide a second communication link.

In 3GPP Long-Term Evolution (LTE) networks, an evolved universal terrestrial radio access network (E-UTRAN) includes a plurality of base stations, e.g., evolved Node-Bs (eNBs) communicating with a plurality of mobile stations referred as user equipment (UEs). Orthogonal Frequency Division Multiple Access (OFDMA) has been selected for LTE downlink (DL) radio access scheme due to its robustness to multipath fading, higher spectral efficiency, and bandwidth scalability. Multiple access in the downlink is achieved by assigning different sub-bands (i.e., groups of subcarriers, denoted as resource blocks (RBs)) of the system bandwidth to individual users based on their existing channel condition. In LTE and 5G NR networks, Physical Downlink Control Channel (PDCCH) is used for downlink scheduling. Physical Downlink Shared Channel (PDSCH) is used for downlink data. Similarly, Physical Uplink Control Channel (PUCCH) is used for carrying uplink control information. Physical Uplink Shared Channel (PUSCH) is used for uplink data. In addition, physical random access channel (PRACH) is used for non-contention based RACH on an LAA carrier.

Listen-Before-Talk (LBT) is a technique used in radio communications, whereby radio transmitters first sense its radio environment (channel) before it starts any transmission. LBT can be used by a radio device to find a channel the device is allowed to operate on or to find a free radio channel to operate on. In New Radio-Unlicensed (NR-U), any downlink and uplink access have to follow the LBT channel access procedure, as unlicensed frequencies are also used by other networks such as WiFi. 3GPP has classified different LBT schemes according to four different LBT categories. The selection of LBT categories goes hand-in-hand with determining a suitable Channel Access Priority Class (CAPC). While there have been recent proposals for LBT and CAPC for user plane (UL and DL) data transmission, LBT and CAPC for control channels also need to be discussed and resolved. 3GPP has introduced four different channel access priority classes for LTE LAA. Selecting the proper LBT type and determining a suitable CAPC is very important for transmission and reception of control messages in NR-U, e.g., for preamble transmission over PRACH in a RACH procedure.

The two main purposes of RACH are to (i) Achieve uplink (UL) synchronization between a specific UE and gNB and (ii) Obtain the resource for Message 3 (e.g., the RRC Connection Request). In a 4-step Contention-Based Random Access (CBRA), UE first transmits the preamble RACH (msg1 or PRACH) and gNB responds with random access response (msg2 or RAR) within the pre-defined RAR window. Subsequently, UE transmits msg3 (UE Identification or RRC Connection Request message) and gNB responds with msg4 (Contention Resolution). Alternatively, in Contention-Free Random Access (CFRA), the gNB first explicitly assigns the RACH Preamble (PRACH) to the UE before UE sends the msg1 in the uplink. 3GPP New Radio (NR) has introduced differentiated Random Access (RA) procedure, with two different priority classes: 1) High Priority RA—RA initiated for (a) Beam Failure Recovery (BFR) and (b) Handover; and 2) Low Priority RA—RA initiated for all other reasons (e.g. Initial Access, Timing Alignment/Out of Sync UE, RRC Reconfiguration etc.).

In 5G NR-U, UE and gNB need to perform LBT and determine CAPC for transmission over PRACH. A solution is sought to allow UE to select a suitable LBT category and to determine an efficient CAPC for PRACH transmission in 5G NR-U wireless communication network.

### SUMMARY

A method for determining Listen Before Talk (LBT) type and Channel Access Priority Class (CAPC) for Physical Random Access Channel (PRACH) transmission in 5G New Radio-Unlicensed (NR-U) is proposed. UE selects a priority of the RACH procedure, depending on the triggering event. UE also selects Category 4 LBT and determines a suitable CAPC based on RACH priority for the PRACH transmission. UE then performs the Category 4 LBT procedure using a set of LBT parameters associated with the determined CAPC value. The RACH procedure has a higher priority if triggered by a beam failure recover (BFR) procedure or a handover (HO) procedure and high priority CAPC is assigned for the corresponding LBT procedure. The RACH procedure has a low priority if triggered by all other reasons and low priority CAPC is assigned for the corresponding LBT procedure.

In one embodiment, a UE prepares a preamble to be transmitted over a physical random access channel (PRACH) to a base station using a RACH procedure over an unlicensed band. The UE determines a priority of the RACH procedure. The UE performs a listen-before-talk (LBT) procedure using a set of LBT parameters associated with a channel access priority class (CAPC). The CAPC is determined according to the priority of the RACH procedure. The UE transmits the preamble over the PRACH upon successfully completing the LBT procedure and the UE receives a random access response (RAR) from the base station.

Other embodiments and advantages are described in the detailed description below. This summary does not purport to define the invention. The invention is defined by the claims.

### BRIEF DESCRIPTION OF THE DRAWINGS

FIG. 1 illustrates an exemplary Licensed Assisted Access (LAA) wireless communications system that adopts Listen Before Talk (LBT) channel access mechanism for physical random access channel (PRACH) transmission in accordance with a novel aspect.

FIG. 2 is a simplified block diagram of a wireless transmitting device and a receiving device in accordance with embodiments of the present invention.

FIG. 3 illustrates a sequence flow between a UE and a base station for scheduling and performing a 4-step RACH procedure using an LBT type and a CAPC value in 5G NR-U in accordance with one novel aspect.

FIG. 4 illustrates a sequence flow between a UE and a base station for scheduling and performing a 2-step RACH procedure using an LBT type and a CAPC value in 5G NR-U in accordance with one novel aspect.

FIG. 5 is flow chart of a method of UE determining LBT categories and suitable Channel Access Priority Class (CAPC) values for PRACH transmission in 5G NR-U in accordance with one novel aspect.

### DETAILED DESCRIPTION

Reference will now be made in detail to some embodiments of the invention, examples of which are illustrated in the accompanying drawings.

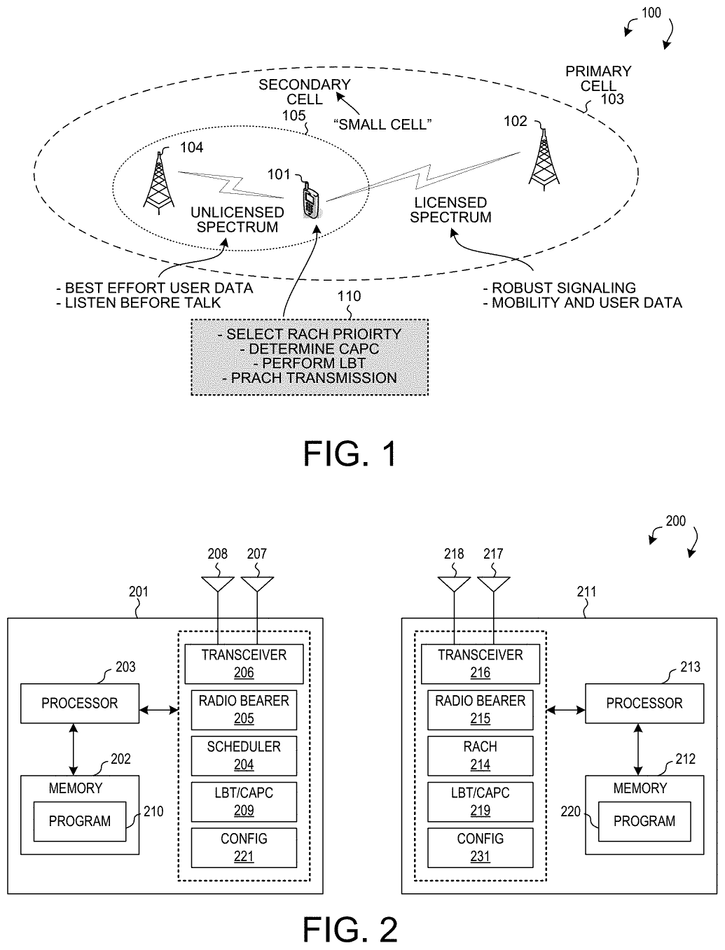

FIG. 1 illustrates an exemplary Licensed Assisted Access (LAA) 5G New Ratio (NR) wireless communications system 100 that adopts listen before talk (LBT) channel access mechanism for Physical Random Access Channel (PRACH) transmission in accordance with embodiments of the current invention. 5G NR wireless communications system 100 includes one or more wireless communication networks, and each of the wireless communication networks has base infrastructure units, such as 102 and 104. The base infrastructure units may also be referred to as an access point, an access terminal, a base station, eNB, gNB, or by other terminology used in the art. Each of the base stations 102 and 104 serves a geographic area. The geographic area served by wireless communications stations 102 and 104 overlaps in this example.

Base station 102 is a licensed base station that communicates with UE 101 via a licensed frequency band. In one example, base station 102 communicates with UE 101 via LTE wireless communication. Base station 102 provides wireless communication to multiple UEs within primary cell 103. Base station 104 is an unlicensed base station that communicates with UE 101 via an unlicensed frequency band. In one example, base station 104 communicates with UE 101 via LTE wireless communication. Base station 104 can communicate with multiple UEs with a secondary cell 105. Secondary cell 105 is also referred to as a “small cell”. Note that, FIG. 1 is an illustrative plot. The base station 102 and base station 104 can be co-located geographically.

The exponential growth in data consumption has created large bandwidth demands that cannot be met by current wireless systems. To meet this ever-increasing demand for data, new wireless systems with greater available bandwidth are needed. Licensed Assisted Access (LAA) wireless networks can be used to provide greater available bandwidth. An LAA network utilizes unlicensed frequency bands in addition to licensed frequency bands contemporaneously, thereby provided additional available bandwidth to the UEs in the wireless system. For example, UE 101 can benefit from simultaneous use of the licensed frequency band and the unlicensed frequency band in an LAA network. The LAA network not only provides additional bandwidth for greater overall data communication, but also provide consistent data connectivity due to the presence of two separate data links. Having multiple data links available increases the probability that the UE will be able to achieve proper data communication with at least one base station at any given moment.

Furthermore, while LAA only utilizes the unlicensed spectrum to boost downlink through a process of carrier aggregation, enhanced LAA (eLAA) allows uplink streams to take advantage of the 5 GHz unlicensed band as well. In NR-Unlicensed (NR-U), not only downlink channels, but uplink channels such as PRACH are also transmitted over the 5 GHz unlicensed band. While utilization of the unlicensed spectrum provides more available bandwidth, the use of the unlicensed spectrum faces practical problems that need to be addressed. To facilitate efficient and fair spectrum sharing, a dynamic spectrum sharing mechanism called listen-before-talk (LBT) channel access procedure needs to be followed for all downlink and uplink transmission in NR-U, as unlicensed frequencies are also used by other networks such as WiFi.

3GPP has classified different LBT schemes according to four different LBT categories. The selection of LBT categories goes hand-in-hand with determining a suitable Channel Access Priority Class (CAPC). 3GPP has introduced four different channel access priority classes for LTE LAA. Naturally, selecting the proper LBT type and determining a suitable CAPC is very important for transmission and reception of control messages in NR-U, e.g., for preamble transmission over PRACH in a RACH procedure. PRACH is the uplink physical channel that is used to (i) achieve uplink (UL) synchronization between a specific UE and gNB; and (ii) obtain the resource for Message 3 (e.g., the RRC Connection Request). 3GPP New Radio (NR) has introduced differentiated Random Access (RA) procedure, with two different priority classes: 1) High Priority RA—RA initiated for (a) Beam Failure Recovery (BFR) and (b) Handover; and 2) Low Priority RA—RA initiated for all other reasons (e.g. Initial Access, Timing Alignment/Out of Sync UE, RRC Reconfiguration etc.).

In accordance with one novel aspect, a method is provided for UE to select a suitable LBT category and to determine an efficient CAPC for PRACH transmission in NR-U wireless communication network. LBT category needs to be selected in such a way that it provides fairness with other unlicensed networks such as WiFi. Similarly, CAPC should be determined depending on the priority of the message, so that higher priority messages are assigned with higher priority CAPC (lower CAPC values). In the example of FIG. 1, UE 101 is connected with gNB 104 over unlicensed band, and UE 101 needs to perform a RACH procedure with gNB 104, triggered by certain events. As depicted by 110, UE 101 first selects a priority of the RACH procedure, depending on the triggering event. UE 101 also determines a suitable CAPC associated with a Category 4 LBT for the PRACH transmission based on the RACH priority. UE 101 then performs the Category 4 LBT procedure using a set of LBT parameters associated with the determined CAPC value. Upon successfully completing the LBT procedure, UE 101 transmits a preamble to gNB 104 over the PRACH. In one embodiment, UE 101 selects Category 4 LBT for all PRACH transmissions because Category 4 LBT offers fairness with other unlicensed network nodes (e.g., WiFi). In another embodiment, the RACH procedure has a higher priority if triggered by a beam failure recover (BFR) procedure or a handover (HO) procedure. Accordingly, high priority CAPC is assigned for the corresponding LBT procedure. In yet another embodiment, the RACH procedure has a low priority if triggered by all other reasons including initial access, timing alignment/out of sync, RRC reconfiguration etc. Accordingly, low priority CAPC is assigned for the corresponding LBT procedure.

FIG. 2 is a simplified block diagram of wireless devices 201 and 211 in accordance with embodiments of the present invention. For wireless device 201 (e.g., a transmitting device), antennae 207 and 208 transmit and receive radio signal. RF transceiver module 206, coupled with the antennae, receives RF signals from the antennae, converts them to baseband signals and sends them to processor 203. RF transceiver 206 also converts received baseband signals from the processor, converts them to RF signals, and sends out to antennae 207 and 208. Processor 203 processes the received baseband signals and invokes different functional modules and circuits to perform features in wireless device 201. Memory 202 stores program instructions and data 210 to control the operations of device 201.

Similarly, for wireless device 211 (e.g., a receiving device), antennae 217 and 218 transmit and receive RF signals. RF transceiver module 216, coupled with the antennae, receives RF signals from the antennae, converts them to baseband signals and sends them to processor 213. The RF transceiver 216 also converts received baseband signals from the processor, converts them to RF signals, and sends out to antennae 217 and 218. Processor 213 processes the received baseband signals and invokes different functional modules and circuits to perform features in wireless device 211. Memory 212 stores program instructions and data 220 to control the operations of the wireless device 211.

The wireless devices 201 and 211 also include several functional modules and circuits that can be implemented and configured to perform embodiments of the present invention. In the example of FIG. 2, wireless device 201 is a base station that includes a radio bearer handling module 205, a scheduler 204, an LBT/CAPC channel access circuit 209, and a configuration circuit 221. Wireless device 211 is a UE that includes a radio bearer handling module 215, a RACH handling module 214, an LBT/CAPC channel access circuit 219, and a configuration circuit 231. Note that a wireless device may be both a transmitting device and a receiving device. The different functional modules and circuits can be implemented and configured by software, firmware, hardware, and any combination thereof. The function modules and circuits, when executed by the processors 203 and 213 (e.g., via executing program codes 210 and 220), allow transmitting device 201 and receiving device 211 to perform embodiments of the present invention.

In one example, the base station 201 establishes a data radio bearer with the UE 211 via radio bearer handing circuit 205, schedules downlink and uplink transmission for UEs via scheduler 204, performs downlink LBT procedure and determines CAPC via channel access circuit 209, and provides configuration information to UEs via configuration circuit 221. The UE 211 establishes a data radio bearer with the base station via radio bearer handing circuit 215, prepares preamble for PRACH transmission via PRACH module 214, performs uplink LBT procedure and determines CAPC via channel access circuit 219, and obtains configuration information via configuration circuit 231. In accordance with one novel aspect, UE 211 determines the LBT categories and CAPC levels based on a priority of the corresponding RACH procedure, which is determined based on the triggering events of the RACH procedure.

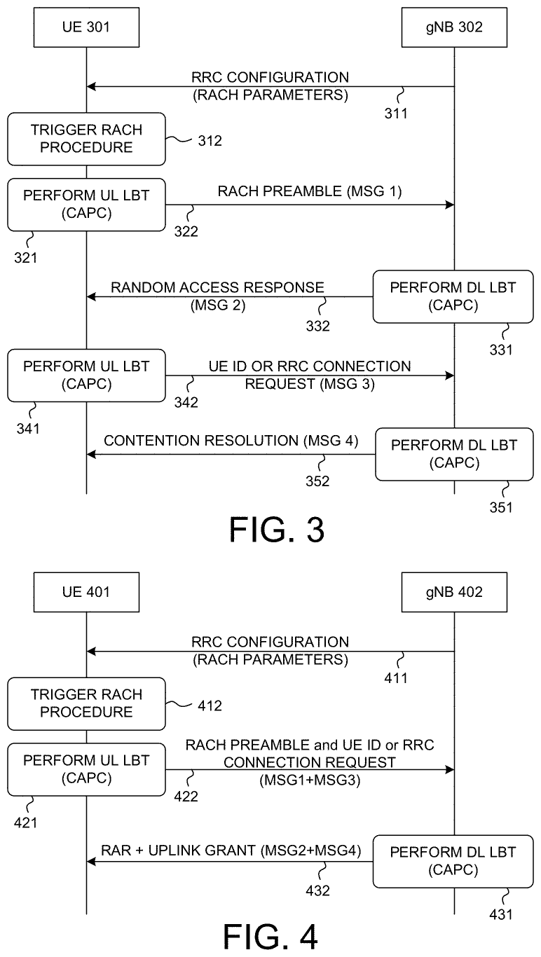

FIG. 3 illustrates a sequence flow between a UE and a base station for scheduling and performing a 4-step RACH procedure using an LBT type and a CAPC value in NR-U in accordance with one novel aspect. In step 311, UE 301 receives RRC signaling message from gNB 302. The RRC configures the power ramping and/or backoff parameters for RACH procedure. In step 312, UE 301 is triggered by certain triggering events to perform a RACH procedure. 3GPP NR has introduced differentiated RA procedure, with two different priority classes: 1) High Priority RA—RA initiated for (a) Beam Failure Recovery (BFR) and (b) Handover; and 2) Low Priority RA—RA initiated for all other reasons (e.g. Initial Access, Timing Alignment/Out of Sync UE, RRC Reconfiguration etc.).

In New Radio-Unlicensed (NR-U), any downlink and uplink access have to follow the LBT channel access procedure, as unlicensed frequencies are also used by other networks such as WiFi. Therefore, once the RA procedure is triggered, both UE 301 and gNB 302 need to perform UL and DL LBT for every UL and DL transmission. In the example of FIG. 3, a 4-step RACH procedure is illustrated, where each step of the RACH procedure is proceeded by an LBT channel access procedure.

There are four different categories of LBT for accessing a shared wireless medium. Category 1 (No LBT) means no LBT procedure is performed by the transmitting entity. Category 2 (LBT without random backoff) means the duration of time that the channel is sensed to be idle before the transmitting entity transmits is deterministic. For Category 3 (LBT with random backoff with a contention window of fixed size), the transmitting entity draws a random number N within a contention window (CW). The size of the contention window is specified by the minimum and maximum value of N. The size of the contention window is fixed. The random number N is used in the LBT procedure to determine the duration of time that the channel is sensed to be idle before the transmitting entity transmits on the channel. For Category 4 (LBT with random backoff with a contention window of variable size), the transmitting entity draws a random number N within a contention window. The size of the contention window is specified by the minimum and maximum value of N. The transmitting entity can vary the size of the contention window when drawing the random number N. The random number N is used in the LBT procedure to determine the duration of time that the channel is sensed to be idle before the transmitting entity transmits on the channel. Category 4 LBT takes longer time and has lower success rate as compared to other LBT procedures, but offers fairness with other unlicensed network nodes.

According to 3GPP specification, while Category 4 (also termed as type-1) LBT involves a random back-off with a variable size contention window, Category 2 (also termed as type-2) is basically an LBT without any random back-off. 3GPP specification also mentions that Category 4 LBT scheme is designed to ensure fairness with Wi-Fi. On the other hand, Category 2 LBT is generally used for short messages, like Discovery Reference Signal (DRS). While there have been recent proposals for LBT and CAPC for user plane (UL and DL) data transmission, LBT and CAPC for RACH also needs to be discussed and resolved. As RACH messages are typically large in size and Category 4 LBT offers fairness with other unlicensed nodes (e.g. WiFi), in accordance with one novel aspect, UE selects Category 4 LBT for all RACH transmissions by default.

The selection of LBT categories goes hand-in-hand with determining a suitable Channel Access Priority Class (CAPC). 3GPP has introduced four different channel access priority classes for LTE LAA. Table 1 below shows the different priority classes, where the smaller the number of the class, the higher the priority. Each priority class uses different T_{mcot,p}, which refers to the maximum channel occupancy time for priority class p. For the priority Classes 3 and 4, T_{mcot,p} is 10 ms, if the absence of any other co-located technology sharing the same spectrum band can be guaranteed on a long-term basis. In a different case, it is limited to 8 ms. According to the 3GPP standards, a device cannot continuously transmit in the unlicensed spectrum for a period longer than T_{mcot,p}.

TABLE 1
Different CAPC Defined in 3GPP Standards

| CAPC | mₚ | CW_{min, p} | CW_{max, p} | T_{MCOT, p} | Allowed CWp sizes |
|---|---|---|---|---|---|
| 1 | 1 | 3 | 7 | 2 ms | 3, 7 |
| 2 | 1 | 7 | 15 | 3 ms | 7, 15 |
| 3 | 3 | 15 | 63 | 8 or 10 ms | 15, 31, 63 |
| 4 | 7 | 15 | 1023 | 8 or 10 ms | 15, 31, 63, 127, 255, |
| | | | | | 511, 1023 |

Category 4 LBT requires determination of CAPC, where lower CAPC values reflect higher priority. CAPC should be determined depending on the priority of the message, so that higher priority messages are assigned with higher priority CAPC (lower CAPC values). Hence, once LBT is performed, UE needs to determine the suitable CAPC for the corresponding RACH transmission. The Maximum Channel Occupancy Time (MCOT) in Table 1 defines the maximum time allowed to share the channel among an access point and the served nodes, and is specified in certain regional regulation. In is proposed all four different CAPC values can be used for LBT category 4 for RACH transmission in NR-U. In addition, since different RA procedures have different types and priorities depending on reason for triggering, it is further proposed that CAPC for RACH messages in NR-U should be based on the purpose (reason) for RACH triggering.

Table 2 below shoes different RA types and its corresponding reasons for trigger. In accordance with one novel aspect, differentiated Random Access is explored for estimation of CAPC during Random Access in NR-U. More specifically, high priority CAPC should be assigned for RACH triggered for beam failure and handover. CAPC for other reasons of RACH should be assigned with low priority, as depicted in Table 3 below.

TABLE 2
RA Types and Formats in NR

| # | RA Type | Reasons of RACH Trigger |
|---|---|---|
| 1 | High Priority RA | a) Beam Failure Recovery (BFR) |
| | | b) Hand Over (HO) |
| 2 | Low Priority RA | All other reasons, e.g. Initial |
| | | Access. Timing Alignment/Out of |
| | | Sync UE, RRC Reconfiguration etc. |

TABLE 3
CAPC Determination for RACH

| Purpose for RACH | CAPC (for RACH) |
|---|---|
| Beam Failure Recovery | 1 (High Priority) |
| Handover | |
| All other reasons for RACH | 2 (Low Priority) |

In the example of FIG. 3, UE 301 performs the 4-step RACH procedure after it is triggered in step 312. UE 301 then determines that a Category 4 LBT with a corresponding CAPC value will be applied during the RACH procedure. Assume Table 3 can be used to map RACH differentiation to different CAPC values. Note that such table can be configured and signaled to the UE via RRC signaling, e.g., in step 311. Alternatively, the table can be hardcoded and used in specification. In step 321, UE 301 performs UL LBT with a CAPC value and transmits RACH preamble (MSG1) upon success LBT (step 322). In step 331, gNB 302 performs DL LBT and transmits a random access response (MSG2, RAR) to UE 301 (step 332). In step 341, UE 301 performs another UL LBT with a CAPC value and transmits UE ID or RRC connection request (MSG3) upon success LBT (step 342). In step 351, gNB 302 performs another DL LBT and transmits an uplink grant with contention resolution (MSG4) to UE 301 (step 352) to complete the RACH process. Note that during the RACH process, MSG1 and MSG3 are sent by the UE, and MSG1 and MSG3 should use the same CAPA value. On the other hand, MSG2 and MSG4 are sent by the network, the choice of CAPC for MSG2 and MSG4 should be left to the network implementation. The network could be guided using the similar principles for estimating CAPC for MSG2 and MSG4.

FIG. 4 illustrates a sequence flow between a UE and a base station for scheduling and performing a 2-step RACH procedure using an LBT type and a CAPC value in NR-U in accordance with one novel aspect. In step 411, UE 401 receives RRC signaling message from gNB 402. The RRC configures the power ramping and/or backoff parameters for RACH procedure. In one example, the RRC also configures the mapping from RACH differentiation to different CAPC values. In step 412, UE 401 is triggered by certain triggering events to perform a RACH procedure. UE 401 then determines that a Category 4 LBT with a corresponding CAPC value will be applied during the RACH procedure. In the example of FIG. 4, the RACH procedure is a 2-step RACH procedure, and the LBT mechanism and CAPC determination proposed above for a 4-step RACH procedure is extended to the 2-step RACH as well. During the 2-step RACH, MSG1 and MSG3 are combined in the first step (421 and 422), and MSG2 and MSG4 are combined in the second step (431 and 432). Category 4 LBT is used for uplink message for the 2-step RACH in NR-U, and CAPC estimation based on RACH priority is also used for the 2-step RACH in NR-U.

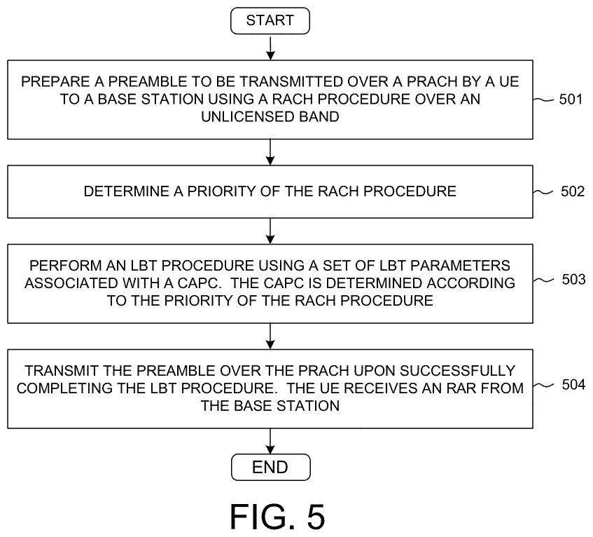

FIG. 5 is flow chart of a method of UE determining LBT categories and suitable Channel Access Priority Class (CAPC) values for PRACH transmission in accordance with one novel aspect. In step 501, a UE prepares a preamble to be transmitted over a physical random access channel (PRACH) to a base station using a RACH procedure over an unlicensed band. In step 502, the UE determines a priority of the RACH procedure. In step 503, the UE performs a listen-before-talk (LBT) procedure using a set of LBT parameters associated with a channel access priority class (CAPC). The CAPC is determined according to the priority of the RACH procedure. In step 504, the UE transmits the preamble over the PRACH upon successfully completing the LBT procedure and the UE receives a random access response (RAR) from the base station.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
preparing a preamble to be transmitted over a physical random access channel (PRACH) by a user equipment (UE) to a base station using a RACH procedure over an unlicensed band;
determining a priority of the RACH procedure;
performing a listen-before-talk (LBT) procedure using a set of LBT parameters associated with a channel access priority class (CAPC), wherein the CAPC is determined according to the priority of the RACH procedure; and
transmitting the preamble over the PRACH upon successfully completing the LBT procedure, wherein in response the UE receives a random access response (RAR) from the base station.

2. The method of claim 1, wherein a Category 4 LBT is selected as a default LBT category for the LBT procedure in the RACH procedure.

3. The method of claim 1, wherein the RACH procedure is either a high priority RA or a low priority RA.

4. The method of claim 3, wherein the high priority RA is triggered by a beam failure recovery (BFR) procedure or a handover (HO) procedure.

5. The method of claim 3, wherein the low priority RA is triggered by initial access, timing alignment, or radio resource control (RRC) reconfiguration.

6. The method of claim 3, wherein the high priority RA is assigned with a high priority CAPC to be associated with the set of LBT parameters.

7. The method of claim 3, wherein the low priority RA is assigned with a low priority CAPC to be associated with the set of LBT parameters.

8. The method of claim 1, further comprising:
transmitting an uplink request to the base station upon successfully completing a second LBT procedure; and
receiving an uplink grant from the base station.

9. The method of claim 8, wherein the second LBT procedure is performed using the same set of LBT parameters associated with the same CAPC.

10. The method of claim 8, wherein the RACH procedure is a two-step RA, and wherein the UE transmits the preamble and an uplink request to the base station, and wherein the UE in response receives the RAR and an uplink grant from the base station.

11. A User Equipment (UE), comprising:
a random access channel (RACH) handling circuit that prepares a preamble to be transmitted over a physical random access channel (PRACH) by the UE to a base station using a RACH procedure in over an unlicensed band, wherein the UE determines a priority of the RACH procedure;
a listen-before-talk (LBT) handling circuit that performs an LBT procedure using a set of LBT parameters associated with a channel access priority class (CAPC), wherein the CAPC is determined according to the priority of the RACH procedure; and
a transmitter that transmits the preamble over the PRACH upon successfully completing the LBT procedure, wherein in response the UE receives a random access response (RAR) from the base station.

12. The UE of claim 11, wherein a Category 4 LBT is selected as a default LBT category for the LBT procedure in the RACH procedure.

13. The UE of claim 11, wherein the RACH procedure is either a high priority RA or a low priority RA.

14. The UE of claim 13, wherein the high priority RA is triggered by a beam failure recovery (BFR) procedure or a handover (HO) procedure.

15. The UE of claim 13, wherein the low priority RA is triggered by initial access, timing alignment, or radio resource control (RRC) reconfiguration.

16. The UE of claim 13, wherein the high priority RA is assigned with a high priority CAPC to be associated with the set of LBT parameters.

17. The UE of claim 13, wherein the low priority RA is assigned with a low priority CAPC to be associated with the set of LBT parameters.

18. The UE of claim 11, wherein the UE transmits an uplink request to the base station upon successfully completing a second LBT procedure, and wherein the UE receives an uplink grant from the base station.

19. The UE of claim 18, wherein the second LBT procedure is performed using the same set of LBT parameters associated with the same CAPC.

20. The UE of claim 18, wherein the RACH procedure is a two-step RA, and wherein the UE transmits the preamble and an uplink request to the base station, and wherein the UE in response receives the RAR and an uplink grant from the base station.
